(19) United States
(12) Patent Application Publication
(10) Pub. No.: US 2014/0178587 A1
(43) Pub. Date: Jun. 26, 2014

(54) METHOD FOR MANUFACTURING COATED MATERIAL CONTAINING STRING-SHAPED FILLER

(71) Applicant: FUJIFILM Corporation, Tokyo (JP)

(72) Inventors: Satoshi KUNIYASU, Ashigarakami-gun (JP); Takahiro HAYASHI, Ashigarakami-gun (JP)

(73) Assignee: FUJIFILM Corporation, Tokyo (JP)

(21) Appl. No.: 14/189,473

(22) Filed: Feb. 25, 2014

Related U.S. Application Data
(63) Continuation of application No. PCT/JP2012/070798, filed on Aug. 16, 2012.

(30) Foreign Application Priority Data
Sep. 7, 2011 (JP) 2011-195312

(51) Int. Cl. B05D 1/26

(52) U.S. Cl. CPC B05D 1/26
USPC 427/286

(57) ABSTRACT

The present invention is a method for manufacturing a coated material containing a string-shaped filler using a coating device which applies a coating fluid by forming a coating fluid bead in a clearance between a running web wound on a backup roller and a coating head tip, comprising at least an applying step of applying to the web the coating fluid containing a large number of metal nanowires and a drying step of drying a coating layer that has been applied, wherein the clearance is set so as to satisfy h<d≦3h, where h indicates the wet film thickness of the coating fluid and d indicates the clearance.

### BACKGROUND OF THE INVENTION

1. Field of the Invention

The present invention relates to a method for manufacturing a coated material containing a string-shaped filler and particularly to a technique for applying a coating fluid containing a string-shaped filler using a coating device which performs application by forming a coating fluid bead in a clearance between a running web wound on a backup roller and a coating head tip.

2. Description of the Related Art

A product obtained by applying to a web a coating fluid containing a plurality of metal nanowires is drawing attention in use application as a transparent conductor for example.

The transparent conductor includes a substrate (web) having high transmittance and insulation properties, and a thin conductive film formed on the substrate. The transparent conductor is produced so as to have surface conductivity as well as a sufficient light transmission property. The transparent conductor having surface conductivity can be used extensively as a transparent electrode for a flat type liquid crystal display, a touch panel, an electroluminescence device, and a thin film solar battery cell, and also as an antistatic layer and an electromagnetic wave shielding layer.

As a suitable method for manufacturing the transparent conductor, U.S. Patent Application Laid-Open No. 2007/0074316 is known. In U.S. Patent Application Laid-Open No. 2007/0074316, a metal nanowire network layer (a layer in which a plurality of metal nanowires are connected in the form of mesh) is formed by feeding a plurality of metal nanowires onto a substrate (the metal nanowires are dispersed in liquid) and drying the liquid. Moreover, in U.S. Patent Application Laid-Open No. 2007/0074316, a metal nanowire network layer is formed by feeding a plurality of metal nanowires onto a substrate, dispersing the metal nanowires in liquid, and drying the liquid, and a conductive layer containing a matrix and metal nanowires embedded in the matrix is formed by feeding a matrix material onto the metal nanowire network layer and curing the matrix material to make the matrix. Furthermore, U.S. Patent Application Laid-Open No. 2007/0074316 discloses that the method is carried out in a roll to roll process.

According to the method described in U.S. Patent Application Laid-Open No. 2007/0074316, a transparent conductor having desirable electrical, optical, and mechanical properties can be produced by a process that is applicable to various substrates at low cost and at high throughput.

Moreover, a carbon nanotube that has been expected as mechanical and functional materials in various fields in recent years is also used as a conductive material of the transparent conductor, and the transparent conductor is produced by applying a coating fluid containing a carbon nanotube to a substrate and drying the fluid.

### SUMMARY OF THE INVENTION

However, when the coating fluid containing a string-shaped filler such as the metal nanowire or the carbon nanotube is applied by a coating device which applies a coating fluid through a coating fluid bead such as an extrusion type or a slide die type coating device, there is a problem that coating stripe failure occurs. The transparent conductor having coating stripe failure cannot have uniform electrical properties, optical properties, or mechanical properties and becomes a defective product. Moreover, in the case of not only a string-shaped filler having conductivity such as a metal nanowire or a carbon nanotube but also a string-shaped filler not having conductivity, there is also a problem of coating stripe failure.

The present invention has been made in consideration of such circumstances and intends to provide a method for manufacturing a coated material containing a string-shaped filler in which method the coating stripe failure can be prevented even when a coating fluid containing a nano-sized string-shaped filler is applied to a web using a coating device which performs application by forming a coating fluid bead in a clearance between a running web wound on a backup roller and a coating head tip.

In order to achieve the object, a method for manufacturing a coated material containing a string-shaped filler according to the present invention is a method for manufacturing a coated material containing a string-shaped filler using a coating device which applies a coating fluid by forming a coating fluid bead in a clearance between a running web wound on a backup roller and a coating head tip, comprising at least: an applying step of applying to the web the coating fluid containing a large number of nano-sized string-shaped filler; and a drying step of drying a coating layer applied in the applying step, wherein the clearance is set so as to satisfy h<d≦3h in the applying step, where h indicates the wet film thickness of the coating fluid and d indicates the clearance.

According to the method for manufacturing a coated material containing a string-shaped filler of the present invention, a clearance is set so as to satisfy h<d≦3h in the applying step, where h indicates the wet film thickness of the coating fluid and d indicates the clearance. Thereby, it is possible to prevent the coating stripe failure from occurring even when a coating fluid containing a nano-sized string-shaped filler is applied to a web using a coating device which performs application by forming a coating fluid bead in a clearance between a running web wound on a backup roller and a coating head tip.

The inventors of the present invention has found that, when the die coating is carried out while a web is wound on a backup roller, the common sense of those skilled in the technical field of coating that a coating head tip is arranged not too close to the web by securing a clearance of about 10 times relative to the wet film thickness becomes the cause of the coating stripe failure in the application of the coating fluid containing a nano-sized string-shaped filler. And by the coating in which the clearance is set to as narrow as 3 times or less of the wet film thickness, the coating being inconceivable and thoughtless conventionally, the occurrence of the coating stripe failure has been able to be prevented. In addition, it is natural that the clearance be larger than the wet film thickness.

It is considered as follows as the reason for which the coating stripe failure is prevented by making the clearance as narrow as 3 times or less of the wet film thickness. Namely, it is considered that a vortex flow is generated in the coating fluid bead as the clearance to the wet film thickness is made larger, the vortex flow causes aggregate to be generated in the coating fluid bead by entangling the string-shaped fillers, and the coating stripe occurs from the aggregate as a starting point. On the other hand, it is considered that since the vortex flow in the coating fluid bead is suppressed as the clearance to the wet film thickness is made smaller, the generation of the aggregate in which string-shaped fillers are entangled is prevented and thereby the coating stripe failure is prevented. And it is considered that the relation between the wet film thickness and the clearance critical in suppressing the generation of the aggregate in which string-shaped fillers are entangled and preventing the coating stripe failure is the relation between the clearance and the wet film thickness in which relation the clearance is 3 times relative to a wet film thickness of 1.

In the method for manufacturing a coated material containing a string-shaped filler according to the present invention, it is preferable that the d is 500 μm or less. It is because when the clearance d becomes too wide exceeding 500 μm, the effect of gravity on the coating fluid bead cannot be ignored and therefore the coating fluid bead becomes unstable.

In the method for manufacturing a coated material containing a string-shaped filler according to the present invention, it is preferable that the string-shaped filler is a metal nanowire or a carbon nanotube.

It is a matter of course that the present invention is applicable to the coating fluids containing a nano-sized string-shaped filler at large because a coated material using a coating fluid containing a metal nanowire or a carbon nanotube drawing attention as a functional material is particularly useful as the transparent conductor.

In the method for manufacturing a coated material containing a string-shaped filler according to the present invention, it is preferable that the major axis diameter of the string-shaped filler is 1 to 100 μm and the minor axis diameter of the string-shaped filler is 1 to 500 nm. The ranges specifically show the suitable ranges as the string-shaped filler that is contained in the coating fluid.

In the method for manufacturing a coated material containing a string-shaped filler according to the present invention, it is preferable that the coating head is an extrusion type or a slide die type. The head specifically shows a preferred aspect of a coating head carrying out coating through a coating fluid bead.

According to the method for manufacturing a coated material containing a string-shaped filler of the present invention, it is possible to prevent the coating stripe failure from occurring even when a coating fluid containing a nano-sized string-shaped filler is applied to a web using a coating device which performs application by forming a coating fluid bead in a clearance between a running web wound on a backup roller and a coating head tip.

### BRIEF DESCRIPTION OF THE DRAWINGS

FIG. 1 is a basic configuration diagram of a manufacturing device which performs a method for manufacturing a coated material containing a string-shaped filler.

FIG. 2A is an explanatory drawing describing a manufactured coated material containing a string-shaped filler (Part 1).

FIG. 2B is an explanatory drawing describing a manufactured coated material containing a string-shaped filler (Part 2).

FIG. 2C is an explanatory drawing describing a manufactured coated material containing a string-shaped filler (Part 3).

FIG. 2D is an explanatory drawing describing a manufactured coated material containing a string-shaped filler (Part 4).

FIG. 3 is an explanatory drawing describing conventional application

FIG. 4 is a drawing showing coating stripe failure occurred by conventional application.

FIG. 5 is an explanatory drawing describing application according to the present embodiment.

FIG. 6 is a drawing showing that coating stripe failure is prevented by the application according to the present embodiment.

FIG. 7 is an explanatory drawing showing manufacturing method of a transparent conductor.

FIG. 8 is an explanatory drawing showing a state of coating that was applied using the present invention in Example.

FIG. 9 is an explanatory drawing showing a state of coating that was applied using the conventional method in Example.

FIG. 10 is a table showing test conditions and test results.

### DETAILED DESCRIPTION OF EXEMPLARY EMBODIMENTS

Hereinafter, the preferred embodiments of the method for manufacturing a coated material containing a string-shaped filler according to the present invention are described in detail in accordance with the attached drawings.

[Basic Description of Method for Manufacturing Coated Material Containing String-Shaped Filler]

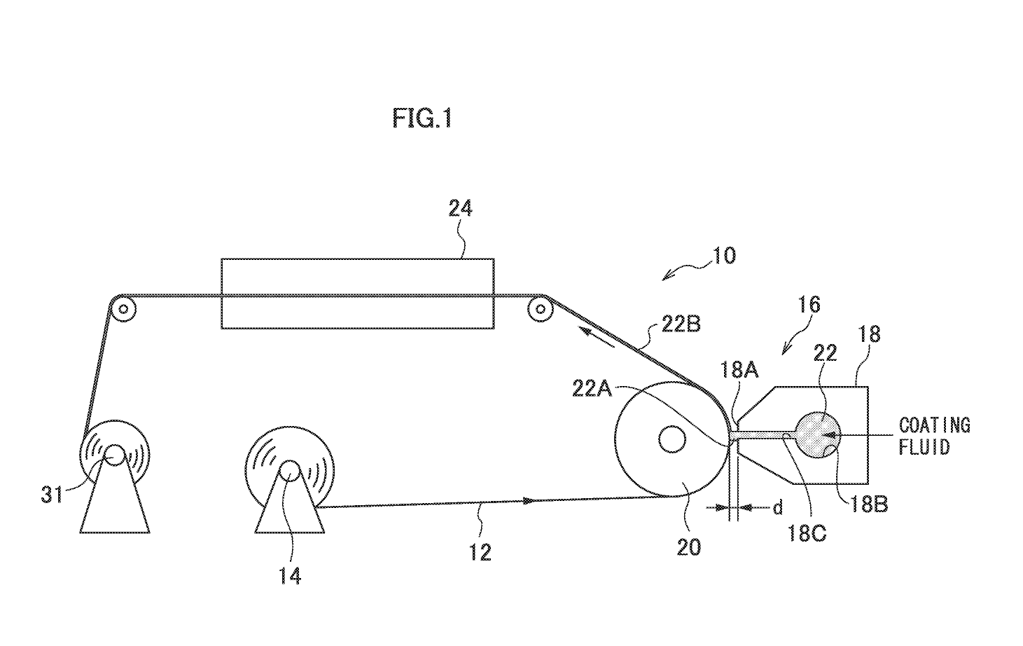

FIG. 1 is a basic configuration diagram showing one example of a manufacturing device 10 carrying out a method for manufacturing a coated material containing a string-shaped filler in the present embodiment.

A web 12 is wound on a feeding reel 14 in a roll shape and is fed toward an extrusion type coating device 16 by the start of the operation of the manufacturing device 10. The extrusion type coating device 16 is constituted mainly from a coating head 18 and a backup roller 20, and the web 12 runs while being wounded on and supported by the backup roller 20. It is preferable that the running speed of the web is in the range of 5 to 150 m/minute. And a predetermined clearance d is set between a coating head tip 18A and the web 12 by moving a coating head 18 back and forth to the backup roller 20.

A material of the web 12 is not particularly limited, and a web made of a resin, paper, a metal, glass or the like can be used.

On the other hand, a coating fluid containing a string-shaped filler, the coating fluid which contains a large number of pieces of a string-shaped filler dispersed in a solvent (hereinafter simply referred to as coating fluid) is prepared by a coating fluid preparing device not shown in the figure and supplied to the coating head 18. It is preferable that the main axis diameter of the string-shaped filler is 1 to 100 μm and the minor axis diameter of the string-shaped filler is 1 to 500 nm.

And the flow of the coating fluid 22 supplied to the coating head 18 is spread at a pocket 18B in the direction of the width of the web (front and back direction in FIG. 1) and thereafter ejected from the coating head tip 18A through a narrow slit 18C toward the one direction of the running web 12. Thereby, the coating fluid bead 22A is formed in the clearance d between the web 12 and the coating head tip 18A, and the coating fluid 22 is coated through the coating fluid bead 22A on the web 12. As a result, a coating layer 22B in which the string-shaped filler is dispersed is formed on the web 12.

In addition, not only the extrusion type coating head but also a slide die type coating head may be used as the coating head 18 carrying out coating with the coating fluid 22. The point is that any type of coating head 18 may be used as long as the coating head 18 applies the coating fluid 22 through the coating fluid bead 22A by forming the coating fluid bead 22A in the clearance d between the web 12 and the coating head tip 18A.

Moreover, it is preferable to carry out pretreatment to the web 12 in order to improve adhesion with the coating fluid 22 applied to the web 12. Examples of the pretreatment include solvent cleaning or chemical cleaning of the web 12, and heating of the web 12, furthermore formation of an undercoat layer for the purpose of imparting an appropriate chemical or ionic state to the coating layer 22B containing a string-shaped filler, and surface treatment of the web 12 such as plasma treatment, UV-ozone treatment or corona discharge.

It is preferable that the undercoat layer is, for example, an undercoat layer that is applied to the surface of the web 12 and can fix a string-shaped filler, particularly a conductive material such as a metal nanowire and a carbon nanotube. It is preferable that the undercoat layer is an undercoat layer that functionalizes and alters the surface of the web 12 and facilitates the binding of the string-shaped filler with the web 12. In the case of applying the undercoat layer, the undercoat layer may be applied to the web in advance of application of the coating fluid 22. Or, the undercoat layer may be applied at the same time of the application of the coating layer with the coating fluid.

Next, the coating layer 22B (i.e., coating) which is applied to the web 12 is dried with a drying device 24, and the solvent in the coating layer is evaporated. Any device may be used as drying device 24 as long as the device is capable of evaporating the solvent in the coating fluid 22. Various drying devices such as a hot air system drying device and an infrared system drying device can be used.

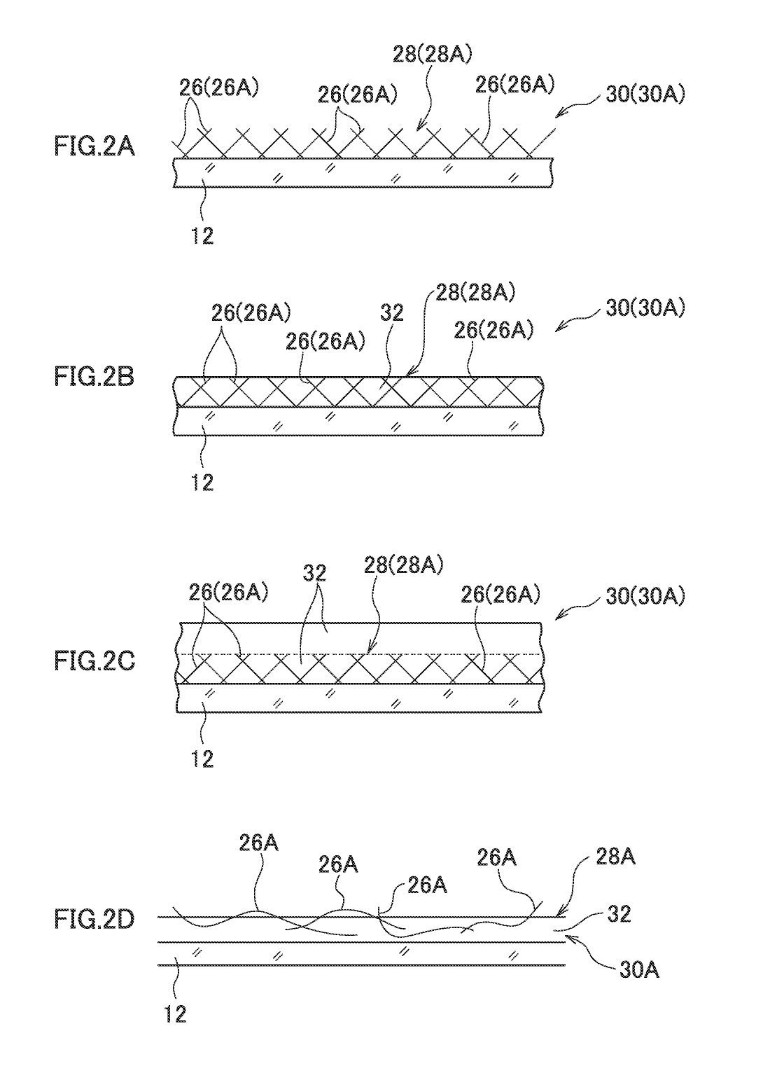

Thereby, a string-shaped filler-containing material 30 having a network layer 28 of the string-shaped fillers 26 is formed on the web 12 as shown in FIG. 2A. The coated material 30 containing a string-shaped filler thus formed is wound on a winding reel 31 as shown in FIG. 1.

A matrix may be formed by applying a matrix material onto the network layer 28 thus formed of the string-shaped fillers 26 by yet another coating device. FIG. 2B is the same as FIG. 2A in that the network layer 28 is formed on the web 12 but is different in that the network layer 28 in which the string-shaped filler 26 is dispersed in a matrix 32 is formed. Moreover, FIG. 2C is the same as FIG. 2A in that the network layer 28 is formed on the web 12 but is different in that the string-shaped filler 26 is dispersed in a state in which the string-shaped filler is completely immersed in the matrix 32.

In addition to the roller coating device, brush, stamp, spray coating devices, slot die coater and every other appropriate coating device can be used for the application of the matrix 32

A “matrix” means a solid material in which the string-shaped filler 26 is dispersed or incorporated, and a “matrix material” means a material or a mixture of materials capable of becoming a matrix by curing. Note that the “matrix” and the “matrix material” are explained in detail in columns describing a method for manufacturing a transparent conductor using a metal nanowire as an example of the string-shaped filler 26.

The clearance d is set so as to satisfy h<d≦3h where h indicates the wet film thickness (thickness in a wet state) of the coating fluid 22 and d indicates the clearance (distance between the coating head tip and the web) in the present embodiment in the method for manufacturing a coated material containing a string-shaped filler.

Thereby, the coating stripe failure can be prevented, the coating stripe failure which has been a problem in the conventional art in applying to the web 12 the coating fluid 22 containing a large number of pieces of a nano-sized string-shaped fillers 26 using the coating device which performs application by forming the coating fluid bead 22A in the clearance d between the running web 12 wound on the backup roller 20 and the coating head tip 18A.

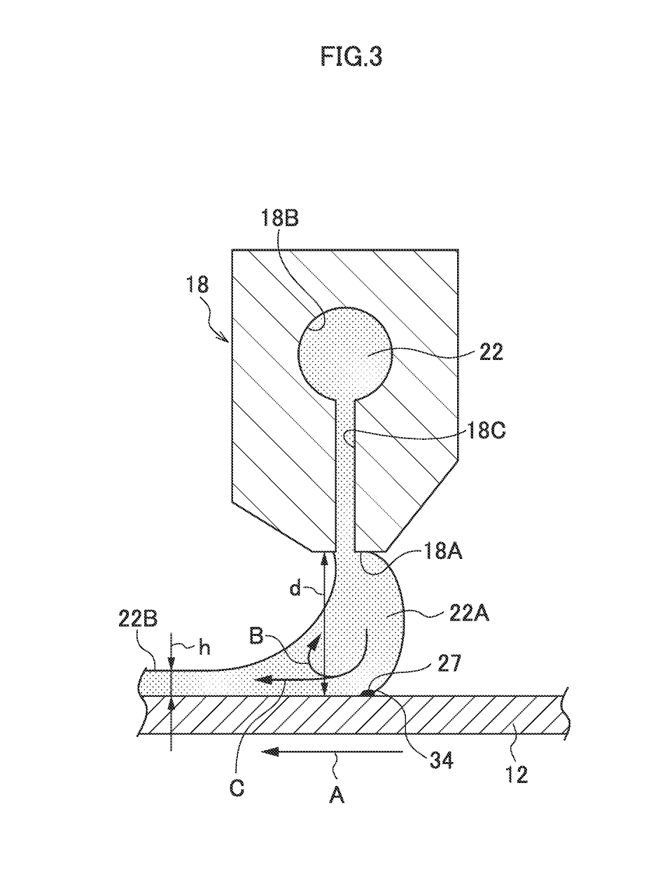

Here, the consideration of the mechanism that can prevent the coating stripe failure by setting the clearance d so as to satisfy h<d≦3h is described by using FIG. 3 to FIG. 6.

FIG. 3 is a schematic diagram showing a coating state in the conventional production of a coated material containing a string-shaped filler, and the backup roller 20 is omitted.

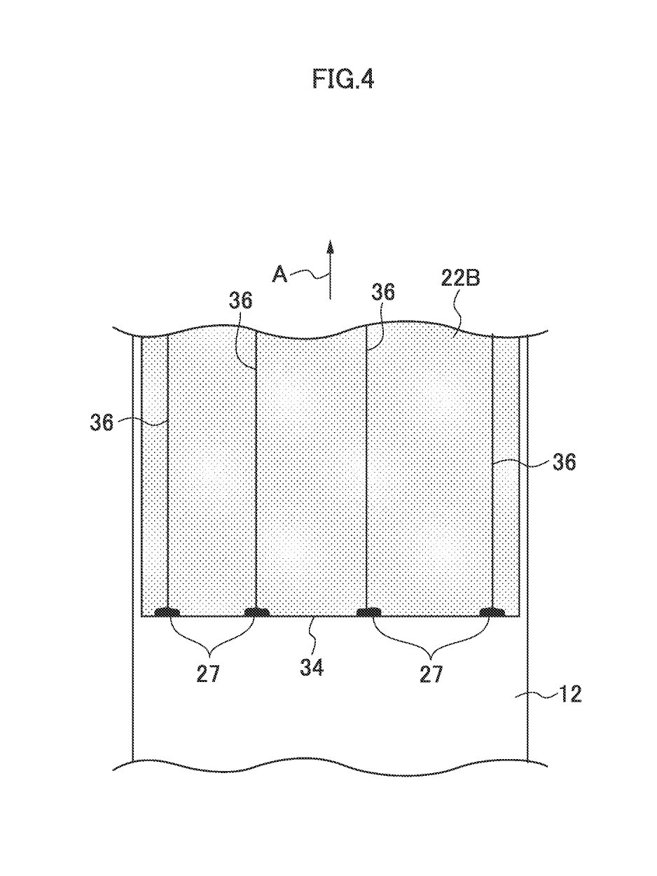

As shown in FIG. 3, the coating fluid 22 ejected from the coating head tip 18A (synonymous with the slit tip) forms the coating fluid bead 22A in the clearance d between the coating head tip 18A and the web 12, and the coating fluid 22 is applied through the coating fluid bead 22A to a surface of the web 12 which is running in the direction of the arrowhead A. FIG. 3 shows a case where the clearance d is more than 3 times wider relative to the wet film thickness h of the coating fluid 22 (5 times, for example). In the conventional art, it has been the common sense of those skilled in the coating technology field to arrange the head tip 18A not too close to the web 12 by securing the clearance d about 10 times, about 5 times even in the case where the clearance is narrower, relative to the wet film thickness h. As a result, since the clearance d relative to the wet film thickness h is too wide, a vortex flow B other than a fluid flow C flowing in the running direction of the web 12 is generated in the coating fluid bead 22A. It is inferred that the string-shaped fillers 26 dispersed in the coating fluid 22 are entangled, and the aggregate 27 is generated by the vortex flow. A large amount of aggregate 27 is observed at a coating end portion 34 (a border portion of a coated region (region which has been coated) and an uncoated region (region which has not been coated yet) on the web 12) as shown in FIG. 3 and FIG. 4, and the coating stripe failure 36 occurs from the aggregate 27 as a starting point.

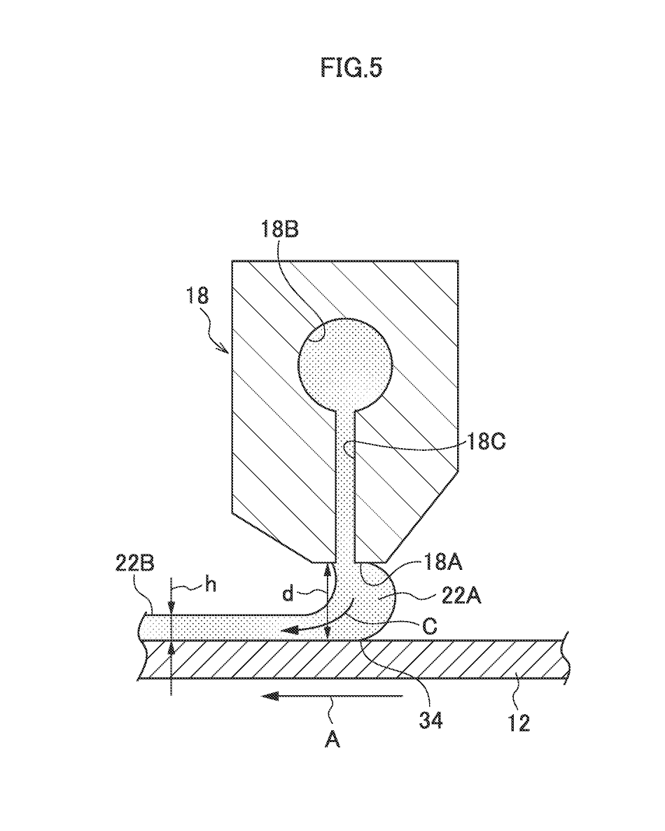

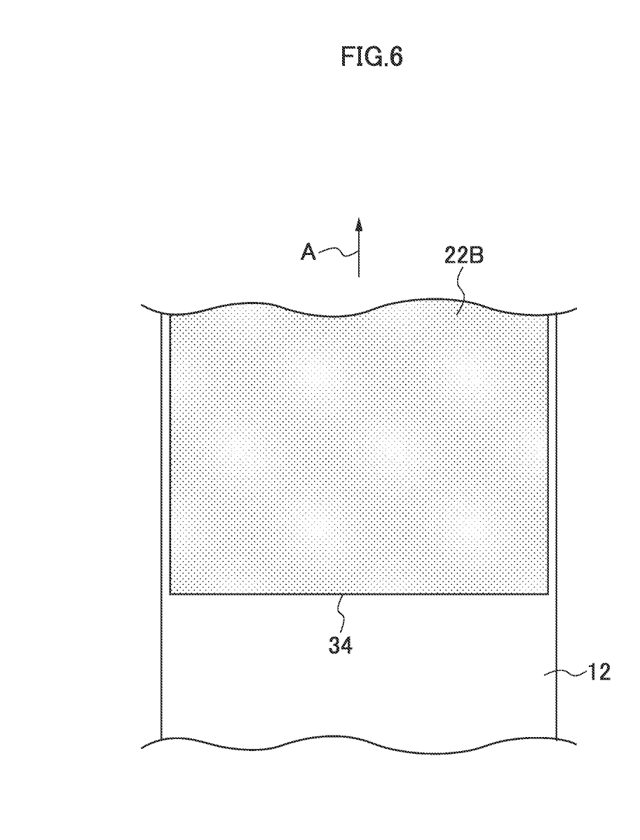

FIG. 5 is a schematic diagram showing a coating state in the production of the coated material containing a string-shaped filler according to the present embodiment and shows a case where the clearance d is set as narrow as 3 times relative to the wet film thickness h of the coating fluid 22. As a result, since the clearance d relative to the wet film thickness h is narrow, the vortex flow is not generated in the coating fluid bead 22A and the coating fluid 22 ejected from the coating head tip 18A forms the liquid flow C flowing only in the running direction of the web 12. As a result, the entangling of the string-shaped fillers 26 dispersed in the coating fluid 22 is suppressed and the aggregate 27 is not formed. Accordingly, as shown in FIG. 5 and FIG. 6, the aggregate 27 of the string-shaped fillers 26 is not accumulated at the coating end portion 34 where the liquid is liable to be retained in the coating fluid bead 22A. This is considered to allow, as shown in FIG. 6, coating excellent in the surface state without the coating stripe failure.

It should be noted that it is obvious that the clearance d is larger than the wet film thickness h. When the clearance d is smaller than the wet film thickness h, not only the coated material 30 containing a string-shaped filler which has a predetermined film thickness (in a dry state) cannot be produced but also there is a risk that the coating head tip 18A contacts with the backup roller 20 to be damaged or the like.

As described above, the cause of the coating stripe failure 36 is that the string-shaped fillers 26 are entangled to form the aggregate 27 due to the vortex flow B in the coating fluid bead 22A. Whether the vortex flow B is generated or not is determined by the relation between the wet film thickness h and the clearance d. Accordingly, the coating stripe failure can be prevented in the range of h<d≦3h, regardless of the physical properties of the coating fluid such as viscosity and surface tension, a web material such as a resin, paper, a metal, and glass, or whether the positions of tip lips of the coating head are lined, or whether overbite or underbite is selected.

However, it is preferable that the clearance d is 500 μm or less. When the clearance becomes too wide exceeding 500 μm, the effect of gravity on the coating fluid bead 22A cannot be ignored. Since the coating fluid bead 22A becomes unstable by the effect of gravity, failure other than the coating stripe failure is liable to occur.

[Method for Producing Transparent Conductor]

Next, the method for manufacturing a transparent conductor as an example of using a conductive nanowire as a string-shaped filler 26 is described. The constitution of the transparent conductor 30A is basically the same as the constitution in FIG. 2 except that the string-shaped filler 26 is replaced by the conductive nanowire (a metal nanowire 26A for example) and the network layer 28 is replaced by a conductive layer 28A that is a conductive network.

(Conductive Nanowire)

The conductive nanowire generally has an aspect ratio of 10 to 100000 (length/diameter). A larger aspect ratio makes it possible to make the overall density of the conductive nanowire lower and to make transparency high. Moreover, since a more effective conductive network can be formed, the aspect ratio is advantageous to obtain a transparent conductive layer 28A. In other words, when a conductive nanowire having a high aspect ratio is used, it becomes possible to make the density of the conductive nanowire that realizes the conductive network sufficiently low to the extent that the conductive network is substantially transparent. In addition, in the case where a PET (polyethylene terephthalate) is used as the web 12, the network layer of the conductive nanowire on the web 12 is substantially transparent in the range from about 440 nm to 700 nm.

Another conductive material having a high aspect ratio (more than 10 for example) in addition to the metal nanowire 26A can be contained as a conductive nanowire. Examples of a non-metal conductive nanowire include, but not limited to, carbon nanotubes (CNTs), metal oxide nanowires, conductive polymer fibers, and the like.

In addition, the present embodiment is described mainly by an example of a metal nanowire 26A. The “metal nanowire” designates a metal wire including an element metal, a metal alloy, or a metal compound (including a metal oxide). The size of at least one cross section (minor axis diameter) of the metal nanowire is less than 500 nm, preferably less than 200 nm, or more preferably less than 100 nm.

As described above, the aspect ratio of the metal nanowire 26A (length to width) is more than 10, preferably more than 50, or more preferably more than 100. The appropriate nanowire can be constituted by all sorts of metals including, but not limited to, silver, gold, copper, nickel, and gold-plated silver.

The metal nanowire 26A can be prepared by a known method. A silver nanowire in particular can be synthesized through liquid phase reduction of silver salt (silver nitrate, for example) under the presence of a polyol (polyethylene glycol for example) and poly(vinylpyrrolidone). Mass production of a silver nanowire having a uniform size can be prepared according to a method described in, for example, Xia, Y. et al., Chem. Mater. (2002), 14, 4736-4745 and Xia, Y. et al., Nanoletters (2003) 3(7), 955-960.

(Conductive Layer and Web)

FIG. 2A described already shows the transparent conductor 30A comprising the conductive layer 28A coated on the web 12. The conductive layer 28A contains a plurality of metal nanowires 26A. The metal nanowires 26A form the conductive network.

FIG. 2B is the same as the example of FIG. 2A in that the conductive layer 28A is formed on the web 12 but is different in that the conductive layer 28A contains a plurality of metal nanowires 26A incorporated in the matrix 32. FIG. 2C is the same as the example of FIG. 2A in that the conductive layer 28A is formed on the web 12 but is different in that the conductive layer 28A is formed by the metal nanowire 26A incorporated in a part within the matrix 32 and completely immersed in the matrix 32.

A part of the metal nanowire 26A may protrude from the matrix 32 in order to enable access to the conductive network. The matrix 32 is a host for the metal nanowire 26A and provides a physical shape of the conductive layer 28A. The matrix 32 protects the metal nanowire layer 26A from disadvantageous environmental factors such as corrosion and abrasion. The matrix 32 in particular prevents penetration of corrosive factors such as moisture under environment, a trace amount of acids, oxygen, and sulfur.

Besides, the matrix 32 imparts favorable physical/mechanical properties to the conductive layer 28A. For example, the matrix 32 can impart adhesive force with the web 12. Furthermore, different from metal oxide films, a polymer matrix or an organic matrix in which the metal nanowire 26A is incorporated can have stiffness and flexibility. In addition, a flexible matrix 32 enables the production of the transparent conductor 30A by low-cost/high-speed mass processing process.

Furthermore, the optical property of the conductive layer 28A can be adjusted by selecting an appropriate matrix material for forming the matrix 32. For example, reflection loss and unnecessary glare can be effectively reduced by using a matrix material having desired refractive index, composition, and thickness.

Generally, the matrix material is an optically transparent substance. When the light transmittance of a substance is at least 80% in the visible region (400 nm to 700 nm), the substance is regarded as optically transparent.

The matrix 32 has a thickness of about 10 nm to 5 μm, a thickness of about 20 nm to 1 μm, or a thickness of about 50 nm to 200 nm, and a refractive index of about 1.3 to 2.5, or about 1.35 to 1.8.

The matrix material may be a polymer (also referred to as polymer matrix) for example. An optically transparent polymer is known in the technical field. Examples of the appropriate polymer matrix include, but not limited to, polymethacrylates (poly(methylmethacrylate) for example), polyacrylic acids such as polyacrylates and polyacrylonitriles, polyvinyl alcohols, polymers having a high aromaticity such as polyesters (polyethylene terephthalates (PET), polyesternaphthalates, and polycarbonates for example), phenol- or cresol-formaldehydes (Novolacs (registered trademark)), polystyrenes, polyvinyltoluenes, polyvinylxylenes, polyimides, polyamides, polyamideimides, polyether amides, polysulfides, polysulfones, polyphenylenes, and polyphenyl ethers, polyurethanes (PU), epoxies, polyolefins (polypropylenes, polymethylpentenes, and cyclic olefins for example), acrylonitrile-butadiene-styrene copolymers (ABS), cellulose derivatives, silicones and other silicon-containing polymers (polysilsesquioxanes and polysilanes for example), polyvinyl chlorides (PVC), polyacetates, polynorbornenes, synthetic rubbers (EPR, SBR, and EPDM for example), and fluoropolymers (polyvinylidene fluorides, polytetrafluoro ethylenes (TFE), or polyhexafluoro propylene for example), copolymers of fluoro-olefin and hydrocarbon olefin (Lumiflon (registered trademark)), and amorphous fluorocarbon polymers or copolymers (CYTOP (registered trademark) manufactured by Asahi Glass Co., Ltd. or TEFLON (registered trademark) AF manufactured by E.I. Du Pont de Nemours and Company).

The matrix material itself may be conductive. For example, the matrix material may a conductive polymer. The conductive polymer is well known in the technical field and includes, but not limited to, poly(3,4-ethylene dioxythiophene) (PEDOT), polyanilines, polythiophenes, and polydiacetylenes.

The “conductive layer 28A” designates the network layer of the metal nanowire 26A providing a conductive medium for the transparent conductor 30A. When the matrix 32 is present, the combination of the network layer of the metal nanowire 26A and the matrix 32 is also referred to as the “conductive layer 28A”. The surface conductivity of the conductive layer 28A is inversely proportional to the surface resistance, is sometimes referred to as sheet resistance, and can be measured by a known method in the technical field.

The conductive layer 28A has to be filled with a sufficient amount of metal nanowires 26A in order to have conductivity. The “reference content” means the weight % of the metal nanowire 26A contained in the conductive layer 28A in the case where the conductive layer 28A has a surface resistivity of about 10⁶ ohm/sq. (or ohm/□) or less. The reference content depends on the aspect ratio, the degree of alignment, the degree of aggregation, the resistivity etc. of the metal nanowire 26A.

The mechanical and optical properties of the matrix 32 is liable to be changed or damaged by feeding every particle in the matrix 32. An advantageous point is that when the aspect ratio of the metal nanowire 26A is high, the conductive network through the matrix 32 can be constructed, in the case of a silver nanowire, so that the reference content is preferably about 0.05 μg/cm² to about 10 μg/cm², more preferably about 0.1 μg/cm² to about 5 μg/cm², more preferably about 0.8 μg/cm² to about 3 μg/cm². These feeding amounts do not affect the mechanical or optical properties of the matrix 32. The values of these feeding amounts strongly depend on the size and the spatial dispersion of the metal nanowire 26A. An advantageous point is that the transparent conductor 30A capable of adjusting the electrical conductivity (or the surface resistivity) and the light transmittance can be provided by adjusting the content of the metal nanowire 26A.

As shown in FIG. 2B, the conductive layer 28A spreads the entire thickness of the matrix 32. An advantageous point is that a certain part of the metal nanowire 26A is exposed on the surface of the matrix 32 due to the surface tension of the matrix material (a polymer for example). The property is particularly useful for use in a touch screen. The transparent conductor 30A exhibits surface conductivity at least one surface thereof.

FIG. 2D describes how the network of the metal nanowires 26A incorporated in the matrix 32 is thought to obtain the surface conductivity. As shown in the figure, while there is a possibility that the metal nanowire 26A is “immersed” in the matrix 32, the end part of the metal nanowire 26A protrudes on the surface of the matrix 32. Moreover, a part of the central part of the metal nanowire 26A may protrude on the surface of the matrix 32. When sufficient numbers of the end parts and the central parts of the metal nanowires 26A protrude on the matrix 32, the surface of the transparent conductor 30A has conductivity.

The “web 12” means a material on which the conductive layer 28A is coated. The web 12 may be transparent or opaque. Examples of the appropriate web 12 having a high stiffness include, but not limited to, polyesters (polyethylene terephthalates (PET), polyester naphthalates, and polycarbonates, for example), polyolefins (straight chain, branched chain, and cyclic polyolefins, for example), polyvinyls (polyvinyl chlorides, polyvinylidene chlorides, polyvinyl acetals, polystyrenes, polyacrylates, for example), cellulose ester based (cellulose triacetates, cellulose acetates, for example), polysulfones such as polyether sulfones, polyimides, silicones, and other conventional polymer films. For example, paper, a metal, glass, or the like can also be used.

(Performance Enhancing Layer)

As described above, the conductive layer 28A has excellent physical and mechanical properties attributable to the matrix 32. These properties can be further enhanced by introducing an additional layer to the transparent conductor 30A. Examples of the additional layer include one or more layers such as a reflection preventing layer, a glare preventing layer, an adhesion layer, a barrier layer, and a hard coat.

(Corrosion Inhibitor)

The transparent conductor 30A may contain a corrosion inhibitor in addition to or in place of the barrier layer. Various corrosion inhibitors protect the metal nanowire 26A based on various mechanisms.

The corrosion inhibitor easily binds with the metal nanowire 26A and forms a protection film on the metal surface. Such a corrosion inhibitor is also referred to as a barrier forming corrosion inhibitor.

All sorts of non-corrosive solvents capable of forming a coating fluid in which the metal nanowire 26A is uniformly dispersed (metal nanowire-containing coating fluid) can be used as a solvent of the coating fluid 22. It is preferable that the metal nanowire 26A is dispersed in water, an alcohol, a ketone, an ether, a hydrocarbon, or an aromatic solvent (such as benzene, toluene, and xylene) in particular. It is more preferable that the solvent is volatile and has a boiling point of 200° C. or less, or 150° C. or less, or 100° C. or less.

Moreover, the coating fluid 22 in which the metal nanowire 26A is dispersed may contain an additive and a binder in order to adjust viscosity, corrosion, adhesive force, and nanowire dispersion. Examples of the appropriate additive and binder include, but not limited to, carboxymethyl cellulose (CMC), 2-hydroxyethyl cellulose (HEC), hydroxypropylmethyl cellulose (HPMC), methyl cellulose (MC), polyvinyl alcohols (PVA), tripropylene glycol (TPG), and xanthane gum (XG), and surfactants such as ethoxylates, alkoxylates, ethylene oxide, and propylene oxide, and copolymers thereof, sulfonate surfactants, sulfate surfactants, disulfonate surfactants, sulfosuccinate surfactants, phosphate ester surfactants, and fluorosurfactants (Zonyl (registered trademark) manufactured by E.I. Du Pont de Nemours and Company for example).

As an example, the coating fluid 22 contains 0.0025 weight % to 0.1 weight % of a surfactant (the preferable range is 0.0025 weight % to 0.05 weight % for Zonyl (registered trademark) FSO-100, for example), 0.02 weight % to 4 weight % of a viscosity modifier (the preferable range is 0.02 weight % to 0.5 weight % for HPMC, for example), 94.5 weight % to 99.0 weight % of a solvent, and 0.05 weight % to 1.4 weight % of a metal nanowire. Representative examples of the appropriate surfactant include Zonyl (registered trademark) FSN, Zonyl (registered trademark) FSO, Zonyl (registered trademark) FSH, Triton (×100, ×114, ×45), Dynol (604, 607), n-dodecyl-b-D-maltoside, and Novek (registered trademark). Examples of the appropriate viscosity modifier include hydroxypropylmethyl cellulose (HPMC), methyl cellulose, xanthane gum, polyvinyl alcohols, carboxymethyl cellulose, and hydroxyethyl cellulose. Examples of the appropriate solvent include water and isopropanol.

When the changes of the concentrations in the coating fluid 22 are required from the above-described values, the percentages of the solvent can be increased or decreased. However, the relative ratio of the other components can be the same in the preferred embodiment. Particularly, the ratio of the surfactant to the viscosity modifier is preferably in the range of 80 to 0.01, the ratio of the viscosity modifier to the metal nanowire is preferably 5 to 0.000625, and the ratio of the metal nanowire 26A to the surfactant is preferably 560 to 5. The ratio of the components of the coating fluid 22 may be appropriately changed according to the web 12 and the coating method to be used. The preferable viscosity range of the coating fluid 22 is 1 to 100 mPa·s.

The matrix material includes polymers, and the same polymers as described above can be used. Moreover, the matrix material includes a prepolymer. The “prepolymer” designates a mixture of monomers, a mixture of oligomers, or a mixture of partial polymers capable of forming a polymer matrix by being polymerized and/or crosslinked. Selecting an appropriate monomer or a partial polymer in consideration of the desired polymer matrix is within the knowledge of those skilled in the art.

The prepolymer is photocurable in the preferred embodiment. Namely, the prepolymer is polymerized and/or crosslinked by irradiation. As described in more detail, the matrix 32 based on the photocurable prepolymer can be patterned by irradiation to a selected region. The prepolymer may be thermosetting, and patterning can be carried out by selective heating from a heat source.

The matrix material is liquid in general. The matrix material may contain a solvent optionally. All sorts of noncorrosive solvents capable of effectively solvating or dispersing the matrix material can be used. Examples of the appropriate solvent include water, alcohols, ketones, tetrahydrofuran, hydrocarbons (cyclohexane for example), or aromatic solvents (benzene, toluene, xylene, etc.). It is more preferable that the solvent is volatile and has a boiling point of 200° C. or less, or 150° C. or less, or 100° C. or less.

The matrix material may contain a crosslinker, a polymerization initiator, a stabilizer (examples include an antioxidizing agent and a UV stabilizer that prolong product life cycle, and polymerization inhibitor that prolongs storage period), a surfactant, or the like. The matrix material may further contain a corrosion inhibitor.

(Method for Manufacturing Transparent Conductor)

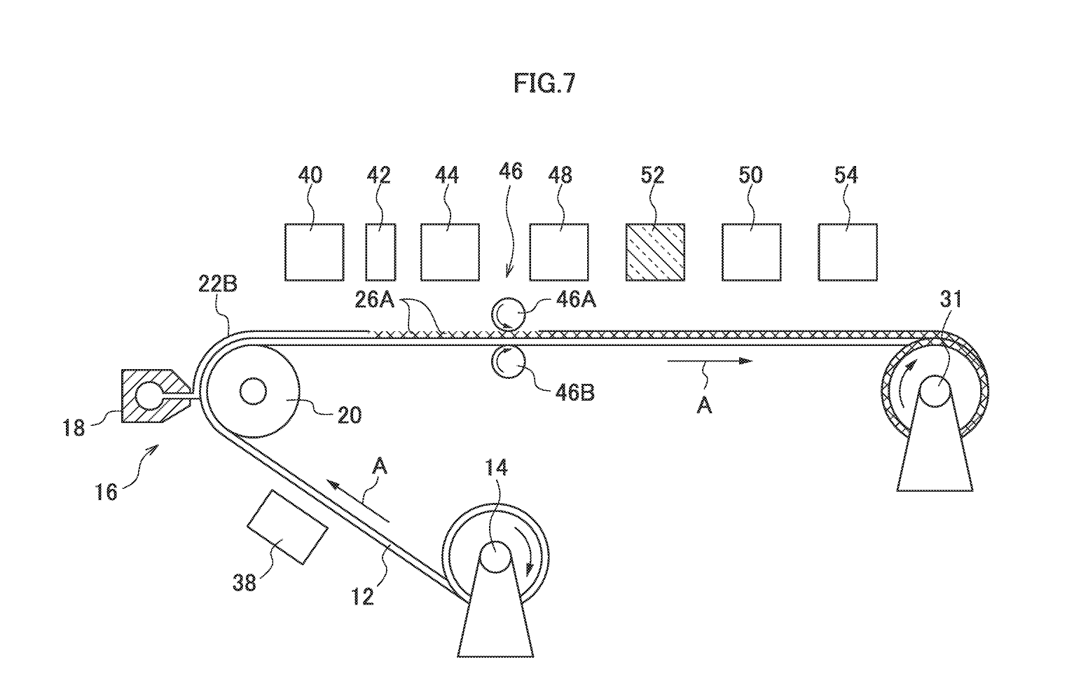

Next, a method for manufacturing the transparent conductor shown in FIG. 2B by a roll to roll system is described by FIG. 7.

As shown in FIG. 7, the web 12 is fed from the feeding reel 14 toward an extrusion type coating device 16.

In the present embodiment, a pretreatment is carried out at a pretreatment station 38. More specifically, it is preferable that a surface treatment is carried out to the web 12 optionally at the pretreatment station 38 in order to improve efficiency of application of the coating fluid 22. In addition, the surface treatment in advance of coating can improve the uniformity of the metal nanowire 26A to be coated.

The surface treatment of the web 12 can be carried out by a known method in the technical field. For example, plasma surface treatment can be used in order to change the molecular structure on the surface of the web 12. The plasma surface treatment can produce a species having a higher reactivity at a low temperature by using a gas such as argon, oxygen, or nitrogen. Generally, since only a small part of the atomic layer on the surface is involved in the step, the bulk property of the web 12 (a polymer film for example) is not changed by the chemical reaction and remains unchanged. In many cases, the plasma surface treatment provides an appropriate surface activity to improve wettability and adhesive binding performance. As a specific example, oxygen plasma treatment can be carried out by a March PX250 system using the following operating parameters. The parameters are 150 W, 30 seconds, the flow rate of oxygen of 62.5 sccm, and the pressure of about 400 mTorr.

The surface treatment may include application of an undercoat layer on the web 12. As described above, the undercoat layer in general has affinity to both of the metal nanowire 26A and the web 12. Accordingly, the undercoat layer enables fixation of the metal nanowire 26A and adhesion of the metal nanowire 26A to the web 12. A representative material suitable as an undercoat layer includes a multi-functional biomolecule including polypeptides (poly-L-lysine for example). Other kinds of typical surface treatments include surface cleaning by a solvent, corona discharge, and UV/ozone treatment, and these types of treatments are known to those skilled in the art.

And the coating fluid 22 is applied to the web 12 fed to the extrusion type coating device 16 by the coating device 16. The coating layer 22B in which the metal nanowire 26A is dispersed is formed on the web 12 by the coating.

It is important that, as described above, the clearance d is set so as to satisfy h<d≦3h where h indicates the wet film thickness of the coating fluid and d indicates the clearance also in such a step of coating.

Thereby, it is possible to prevent the coating stripe failure from occurring even when the coating fluid 22 containing the metal nanowire 26A is applied to the web 12 using the coating device 16 which performs application by forming the coating fluid bead 22A in the clearance d between the running web 12 wound on the backup roller 20 and the coating head tip 18A. Accordingly, the transparent conductor 30A to be manufactured can have uniform electrical properties, optical properties, and mechanical properties.

Next, the web 12 is fed to a rinsing station 40, and the coating layer 22B that has been coated can be rinsed, optionally. Thereafter, the coating layer 22B is dried at a drying station 42. In addition, the drying system is not particularly described in FIG. 7, however a hot air drying device by which hot air is blown to the web 12 while the web 12 passes through the tunnel-form drying device body as shown in FIG. 1 can be preferably used. Thereby, the conductive layer 28A that is the network layer of the metal nanowire 26A is formed on the web 12.

Next, the web 12 on which the conductive layer 28A has been formed is fed to a post-treatment station 44. And the surface treatment of the metal nanowire 26A is carried out by, for example, argon or oxygen plasma. Thereby, the transmittance and conductivity of the conductive layer 28A can be improved. As an example, Ar or N₂ plasma treatment can be carried out by a March PX250 system using the following operating parameters. The parameters are 300 W, 90 seconds (or 45 seconds), the Ar or N₂ gas flow rate of 12 sccm, and the pressure of about 300 mTorr. Another type of surface treatment (corona discharge or UV/ozone treatment for example) may be used in the same way. For example, an Enercon system can be used for corona treatment.

Next, the web 12 is fed to a pressurization treatment station 46 carrying out pressurization treatment of the conductive layer 28A. More specifically, the conductive layer 28A is fed through a roller 46A and a roller 46B, and these rollers apply pressure to the surface of the conductive layer 28A. In the case of applying pressure, a single roller can also be used. An advantageous point of the pressurization treatment is that the conductivity of the conductive layer 28A can be improved when the pressurization treatment of the conductive layer 28A is carried out particularly in advance of application of the matrix material. In the following description, a work in a stage prior to the stage where the transparent conductor 30A is finally formed such as a work in a state where the conductive layer 28A is formed on the web 12 or a work in a state where the matrix 32 is formed in the conductive layer 28A is described as a precursor of the transparent conductor.

Particularly, pressure may be applied to one surface (conductive layer surface) or both surfaces of the web 12 having the conductive layer 28A using one or more rollers (cylindrical bars for example). In the case where the single roller is used, there is a possibility that the conductive layer 28A is formed on a hard surface, the single roller is rotated by using a known method on the exposed surface of the conductive layer 28A while the pressure is applied to the roller. In the case where two rollers 46A and 46B are used, the conductive layer 28A may be subjected to roll treatment between two rollers 46A and 46B.

Furthermore, a pressure of 50 to 10,000 psi may be applied to the conductive layer 28A by one or more rollers. Moreover, a pressure of 100 to 1000 psi, or 200 to 800 psi, or 300 to 500 psi may be applied. Preferably, the pressure is applied to the conductive layer 28A in advance of application of all sorts of matrix material.

In the case where two or more rollers are used in order to apply pressure to the conductive layer 28A, a “nip” or “pinch” roller may be used. The nip or pinch roller is well understood in the technical field and is described in, for example, 3M Technical Report “Lamination Techniques for Converters of Laminating Adhesives” (March, 2004).

When the pressure is applied to the conductive layer 28A either before or after the plasma treatment is applied, the conductivity of the conductive layer is improved, and furthermore the application of the pressure may be carried out regardless of whether the prior or the following plasma treatment is carried out or not. As shown in FIG. 7, rollers 46A and 46B may rotate one or multiple revolutions on the surface of the conductive layer 28A. In the case where the rollers rotate multiple revolutions on the surface of the conductive layer 28A, the rotation may be carried out in the same direction to an axis parallel to the surface of the sheet to which roll treatment is carried out (along with the moving path of the web for example) or may be carried out in the different direction (not shown in the figure).

The conductive layer 28A formed by the metal nanowire 26A after applying a pressure of about 1000 psi to about 2000 psi by using, for example, a stainless steel roller includes a plurality of nanowire intersections. At least a crossover part of an upper surface nanowire at each intersection have a flattened cross section at a point where the metal nanowires are pressed by each other due to the application of the pressure, thereby, in addition to the conductivity, connectivity of the conductive layer 28A formed by the metal nanowire 26A is enhanced.

Furthermore, it is preferable that the conductive layer 28A is heated. Generally, the conductive layer 28A is heated to any temperature ranging from 80° C. to 250° C. for 10 minutes or less, more preferably any temperature ranging from 100° C. to 160° C. for any time between 10 seconds to 2 minutes. The heating can be carried out either online or offline. In the offline process, for example, the conductive layer 28A can be placed for the predetermined time in an oven (described as sheet oven) capable of drying a sheet-like product the temperature of which is set to the predetermined temperature. Heating the conductive layer 28A by such a method is advantageous to improve the conductivity of the transparent conductor 30A. The transparent conductor 30A manufactured by using, for example, the roll to roll treatment as shown in FIG. 7 was placed in the sheet oven in which the temperature was set to 200° C. for 30 seconds in the present embodiment. The transparent conductor 30A had a surface resistivity of about 12 kohm/sq. before the heat treatment, however the surface resistivity was lowered to about 58 ohm/sq. after the heat treatment. For example, an infrared lamp can be used by either an inline or an offline method in order to heat the conductive layer 28A. RF current can also be used in order to heat the conductive layer 28A of the metal nanowire 26A. RF current may be induced in the conductive layer 28A by either broad cast micro wave or current induced through an electrical connecting point to the conductive layer 28A.

Furthermore, a post-treatment applying both heat and pressure to the conductive layer 28A can be used. Particularly, the conductive layer 28A can be arranged through one or more rollers as described above in order to apply pressure. The roller may be heated in order to apply heat simultaneously. The pressure applied by the roller is preferably 10 to 500 psi, more preferably 40 to 200 psi. The roller is heated to preferably 70° C. to 200° C., more preferably 100° C. to 175° C. The conductivity of the conductive layer 28A can be improved by such a combination of applying heat and applying pressure. A machine that can be used in order to apply appropriate pressure and heat simultaneously is a laminator manufactured by Banner American Products of Temecula, Calif. The combination of applying heat and applying pressure can be carried out either before or after coating and curing the matrix layer or another layer as described below.

Another post-treatment method to be used in order to improve the conductivity of the conductive layer 28 is to expose the conductive layer 28A manufactured by the way as described in the present specification to a metal reducing agent. Particularly, the conductive layer 28A of a silver nanowire can be exposed to preferably a silver reducing agent such as sodium borohydride for preferably any time between 10 seconds and 30 minutes, more preferably any time between 1 minute and 10 minutes. Such a treatment can be carried out either online or offline as those skilled in the art understand.

As described above, such a treatment can improve the conductivity of the conductive layer 28A. For example, the conductive layer 28A of the silver nanowire on a PET film prepared according to the roll to roll treatment shown in FIG. 7 was exposed to 2% NaBH₄ for 1 minute, thereafter rinsed with water, and dried in the air. The conductive layer 28A had a resistivity of about 134 ohm/sq. before the post-treatment and had a resistivity of about 9 ohm/sq. after the post-treatment.

Next, the web 12 is fed to a matrix coating station 48 carrying out coating with a matrix material. The matrix coating station 48 may be a storage tank, a spray device, a brushing device, a printing device, or the like. Thereby, the matrix material is applied to the conductive layer 28A. An advantageous point is that the matrix material can be coated by a printing device and formed as a patterned matrix material layer.

Next, the web 12 on which the matrix material is coated is fed to a curing station 50 and cured. In the case where the matrix material is polymer/solvent based, the matrix material layer can be cured by evaporating the solvent. The curing step can be accelerated by heating (calcination for example). In the case where the matrix material contains a radiation curable prepolymer, the matrix material layer can be cured by irradiation. Depending on the type of the prepolymer, thermosetting (heat-induced polymerization) can also be used.

Before the matrix material layer is cured, a patterning step can be carried out optionally. A patterning station 52 is arranged at the back of the matrix coating station 48 and in front of the curing station 50.

The curing step forms the conductive layer 28A in which the metal nanowire 26A is contained in the matrix 32. The conductive layer 28A can be further treated at the post-treatment station 54.

The surface treatment of the conductive layer 28A can be carried out at the post-treatment station 54 in order to expose a part of the metal nanowire 26A on the surface of the conductive layer 28A. A minute amount of the matrix 32 can be removed by etching by, for example, a solvent, plasma treatment, corona discharge, or UV/ozone treatment. The exposed metal nanowire 26A is particularly useful for use in a touch screen.

Some metal nanowires 26A are exposed on the surface of the conductive layer 28A after the curing step (see FIG. 2D), and the etching stage is not needed. Particularly, when the thickness of the matrix 32 and the surface tension of the matrix material are appropriately adjusted, the matrix 32 does not wet the upper conductive layer 28A and a part of the metal nanowire 26A becomes exposed on the surface of the conductive layer 28A. Thereby, the transparent conductor 30A comprising the conductive layer 28A and the web 12 is manufactured. The manufactured transparent conductor 30A is wound on a winding reel 31. The flow process of the manufacturing is also referred to as a “reel to reel” or “roll to roll” process. Stabilization of the web 12 can be done by moving the web 12 along a conveyor belt, optionally.

In the “roll to roll” process, a plurality of covering stages can be carried out along the moving path of the running web 12. Accordingly, the customization or modification in which any numbers of additional covering stations are incorporated as necessary can be done. For example, the covering of the performance enhancing layer (reflection preventing, adhesion, barrier, glare preventing, and protection layers or films) is quite possible to be integrated into the flow process.

### Examples

Nest, with regard to a method for manufacturing a coated material containing a string-shaped filler according to the present embodiment, specific test results in manufacturing a transparent conductor using a silver nanowire (a kind of a metal nanowire) as a string-shaped filler are described.

(1) Formulation of Coating Fluid

The formulation of a coating fluid used for testing is as follows.

| | | |
|---|---|---|
| Silver nanowire (major axis diameter 10 μm, | 0.3 | g |
| minor axis diameter 50 nm) | | |
| Pure water | 60 | g |
| Propanol | 37.7 | g |
| Tetraethoxysilane (TEOS) | 2 | g |
| [Total] | 100 | g |

In addition, the pH of the coating fluid is adjusted to pH 4 with a pH adjusting agent.

(2) Conditions of Coating Step and Drying Step

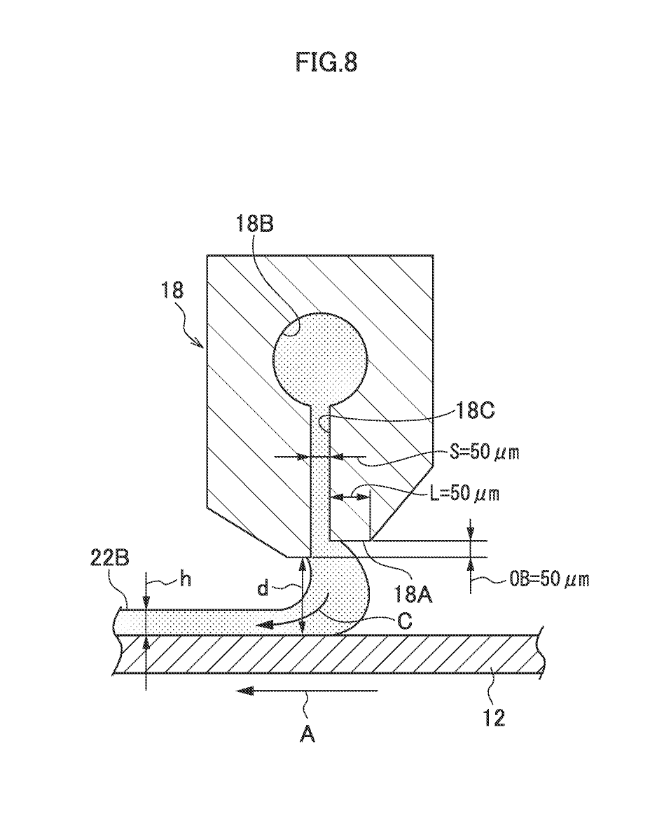

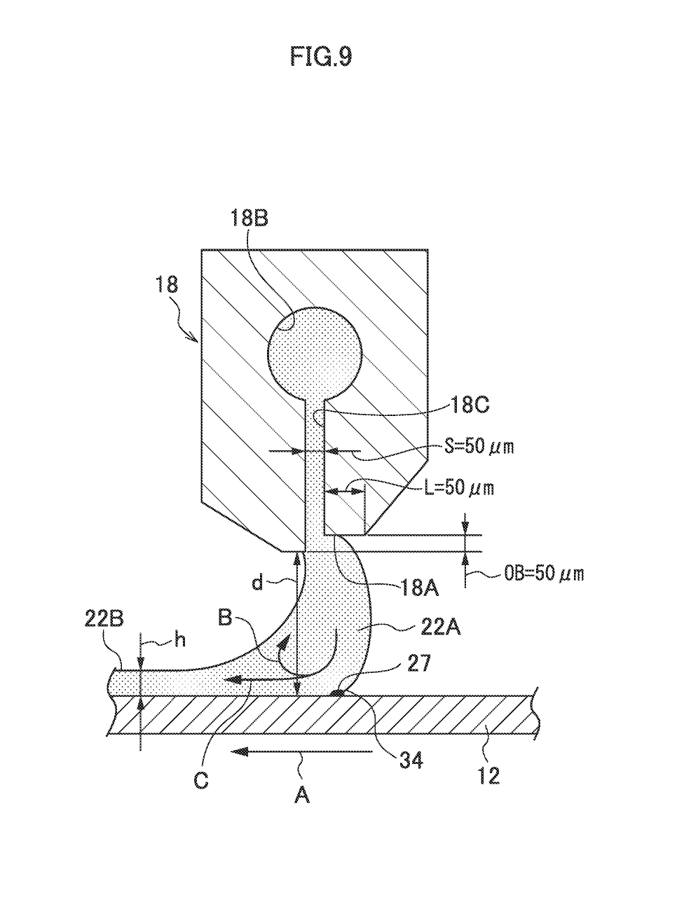

The test was carried out using a manufacturing device shown in FIG. 1.
Coating device 16 . . . An extrusion type coating head 18 comprising a backup roller (not shown in the figure) was used, and the slit interval (S) was set to 50 μm as shown in FIG. 8 (the present invention) and FIG. 9 (conventional method). Moreover, the lip land length (L) of the coating head 18 in the downstream side of the web running direction was set to 50 μm, and the amount of overbite (OB) was made to be 50 μm.
As the web 12, a PET film having a thickness of 120 μm was used, and the silane coupling treatment as well as corona discharge treatment of 4 J/cm² was carried out on the surface of the film.
Drying device 24 . . . A hot air drying device was used, and the coating layer 22B formed by being applied to the web 12 was dried at 120° C. for 1 minute to evaporate the solvent in the coating layer 22B.

(3) Test

And the coating fluid 22 formulated as described above was applied to the running web 12 by the coating device 16. In the coating, the test was carried out to see how the occurrence of the coating stripe failure was changed between the cases where the condition of h<d≦3h was satisfied (FIG. 8) and was not satisfied (FIG. 9) where h indicates the wet film thickness of the coating fluid 22 applied to the web 12 and d indicates the clearance. Namely, the d/h was changed in the range from 2.9 to 17 by changing the clearance d in the range from 20 to 120 μm and the wet film thickness h in the range from 7 to 24 cc/m². Here, a coating amount of 7 cc/m², for example, corresponds to a wet film thickness (thickness of wet film) of 7 μm.

The specific d/h values are 7 for test 1, 10 for test 2, 17 for test 3, 4 for test 4, 3 for test 5, 2.9 for tests 6 to 10, and 2.0 for test 11. In addition, the values rounded to integers were shown in the table.

Moreover, 3 levels oft the web running speed, 12, 24, and 36 m/min were used to determine the effect of the web running speed.

In addition, in the case where a coating head 18 have overbite, the clearance d is defined as the distance from the lip tip in the downstream side of the web running direction to the web 12.

(4) Test Results

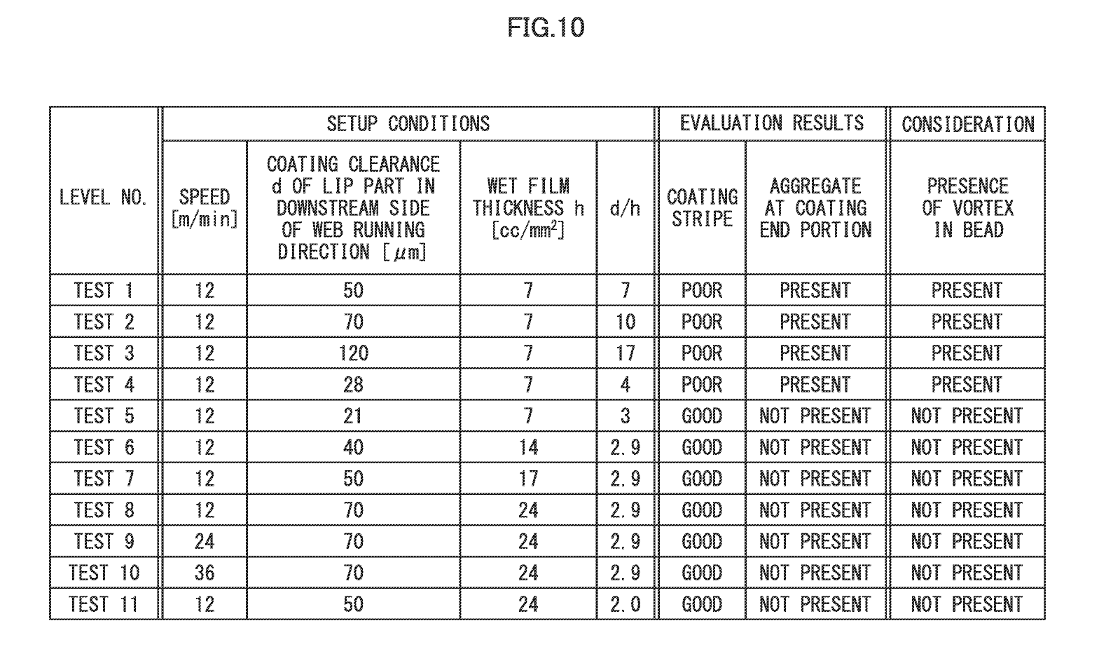

The test results are shown in the table in FIG. 10. As evaluation items, whether the “aggregate at the coating end portion” was present or not was visually observed in addition to the above-described “coating stripe”. Furthermore, whether the vortex flow in the coating fluid bead was present or not was figured out as information for consideration with regard to the cause of the occurrence of the coating stripe by hydrodynamics-based calculation.

In the evaluation of the coating stripe in the table in FIG. 10, POOR means that the coating stripe occurred, and GOOD means that the coating stripe did not occurred.

As a result, the coating stripe 36 (see FIG. 4) occurred in the web running direction about 1 minute after the start of coating in tests 1 to 4 that did not satisfy h<d≦3h, namely the d/h is large, exceeding 3. When the coating end portion 34 was observed, it was confirmed that the aggregates 27 were accumulated in the width direction of the web as shown in FIG. 9. And the coating stripe failure occurred from the aggregate 27 as a starting point. Moreover, when the aggregate 27 was collected and observed by a microscope, the result was that the aggregate 27 was an agglomerate in which silver nanowires were entangled.

Furthermore, since the relation between the wet film thickness h in tests 1 to 4 and the clearance d was the relation by which the vortex flow B was generated in the coating fluid bead 22A, it was inferred that the aggregate 27 was formed by silver nanowires being entangled due to the vortex flow B.

From the above results, tests 5 to 11 were set so that the relation between the wet film thickness h and the clearance d by which relation the vortex flow B was not generated in the coating fluid bead 22A was satisfied, namely tests 5 to 11 were set so that the d/h was 3 or less. As a result, as it was inferred, the coating stripe 36 did not occur and the aggregate 27 at the coating end portion 34 was not observed.

Moreover, even when the web running speed was changed to 3 levels, 12, 24, and 36 m/min, the coating stripe 34 did not occur as long as the d/h was 3 or less.

From the above results, it was confirmed that the coating stripe failure can be eliminated by setting the clearance d so as to satisfy h<d≦3h when the coating fluid 22 containing a silver nanowire is applied to the web 12 using a coating device which performs application by forming the coating fluid bead 22A in the clearance d between the running web 12 wound on the backup roller 20 and the coating head tip 18A.

What is claimed is:

1. A method for manufacturing a coated material containing string-shaped filler using a coating device which applies a coating fluid by forming a coating fluid bead in a clearance between a running web wound on a backup roller and a coating head tip, comprising:
applying to the web the coating fluid containing a large number of pieces of a nano-sized string-shaped filler; and
drying a coating layer that has been applied,
wherein the clearance is set so as to satisfy h<d≦3h in the applying the coating fluid, where h indicates a wet film thickness of the coating fluid and d indicates the clearance.

2. The method for manufacturing a coated material containing a string-shaped filler according to claim 1, wherein the d is 500 μm or less.

3. The method for manufacturing a coated material containing a string-shaped filler according to claim 1, wherein the string-shaped filler is a metal nanowire.

4. The method for manufacturing a coated material containing a string-shaped filler according to claim 1, wherein the string-shaped filler is a carbon nanotube.

5. The method for manufacturing a coated material containing a string-shaped filler according to claim 1, wherein the string-shaped filler has a major axis diameter of 1 to 100 μm and a minor axis diameter of 1 to 500 nm.

6. The method for manufacturing a coated material containing a string-shaped filler according to claim 1, wherein the coating head is an extrusion type or a slide-die type.
